(19) United States
(12) Patent Application Publication
(10) Pub. No.: US 2018/0112452 A1
(43) Pub. Date: Apr. 26, 2018

(54) WINDOW GLASS OPENING/CLOSING SYSTEM FOR VEHICLE

(71) Applicant: MITSUI KINZOKU ACT CORPORATION, Yokohama-shi (JP)

(72) Inventor: Shuntaro KIMURA, Yokohama-shi (JP)

(73) Assignee: MITSUI KINZOKU ACT CORPORATION, Yokohama-shi (JP)

(21) Appl. No.: 15/648,675

(22) Filed: Jul. 13, 2017

(30) Foreign Application Priority Data
Oct. 20, 2016 (JP) 2016-205942

(51) Int. Cl. E05F 15/70; E05B 81/70; E05B 81/68; E05B 77/30

(52) U.S. Cl. CPC E05F 15/70; E05B 81/70; B60J 1/17; E05B 77/30; E05Y 2900/55; E05B 81/68

(57) ABSTRACT

On the basis that a ratchet detection switch detects the releasing operation of a ratchet, and a door opening and closing detection switch detects the opened state of a door, the drive of a motor for a window regulator is controlled so as to open a window glass to a predetermined slight opening position. In addition, on the basis that the door opening and closing detection switch detects the closed state of the door, and the ratchet detection switch detects the engagement of the ratchet to a latch, the drive of the motor for the window regulator is controlled to close the window glass.

### BACKGROUND OF THE INVENTION

The present invention relates to a window glass opening/closing system for vehicles, window glass opening/closing system in which a door latch device for keeping a door in a closed state and a window regulator for opening and closing a window glass are equipped.

Heretofore, as to window glass opening/closing systems for vehicles described, for example, in Japanese Patent Application Publication No. 2004-082808 and United States Patent Application Publication No. 2012/0136532, window glass opening/closing systems in each of which a door latch device and a window regulator are equipped, in particular, in a sashless type in which a door is not equipped with a sash for guiding the lifting and the lowering of a window glass, to improve sealing performance of a weather strip provided at a door opening edge and door closing performance, it has been configured that by the drive control of the window regulator, the window glass is automatically opened to a slight opening position when a detection switch detects the opening operation of the door, and the window glass is automatically closed when the door is closed, and the window glass is surely brought into tight contact with the weather strip.

### SUMMARY OF THE INVENTION

However, the window glass opening/closing systems for vehicles described in JP 2004-082808 (A) and US 2012/0136532 (A1) have been configured so that only when the locking and unlocking mechanism of the door latch device is in an unlocked state, by the opening operation of the door, the window glass is automatically opened to the slight opening position. However, in those configuration, it is not possible to apply an one-motion door latch device configured so that the door can be opened by the opening operation of an inside handle, one-motion door latch device which is provided at a door at, for example, a driver's seat side, even in a case where the locking and unlocking mechanism is in a locked state, because if the one-motion door latch device is applied to each of the window glass opening/closing systems for vehicles which are described in JP 2004-082808 (A) and US 2012/0136532 (A1), although the door can be opened by the opening operation of the inside handle even when the locking and unlocking mechanism is in the locked state, the window glass cannot be automatically opened to the slight opening position.

The present invention was made in view of the above problem. An object of the present invention is to provide a window glass opening/closing system for vehicles, which is configured so that a window glass is automatically opened and closed based on the opening and closing operation of a door, even in any type of a door latch device.

A first invention is characterized in that a window glass opening/closing system for vehicles has: a door latch device including: a latch capable of meshing with a striker; a ratchet capable of engaging with the latch; a ratchet detection switch detecting the releasing operation of the ratchet by the opening operation of a door and the engagement of the ratchet to the latch; and a door opening and closing detection switch detecting the opened state and the closed state of the door; a window regulator for opening and closing a window glass by an electric drive source, window regulator which is provided at the door; and a control device controlling the electric drive source of the window regulator, wherein the control device controls the drive of the electric drive source to open the window glass to a predetermined slight opening position on the basis that the ratchet detection switch detects the releasing operation of the ratchet, and wherein the control device controls the drive of the electric drive source to close the window glass on the basis that the door opening and closing detection switch detects the closed state of the door, and the ratchet detection switch detects the engagement of the ratchet to the latch.

A second invention is characterized in that a window glass opening/closing system for vehicles has: a door latch device including: a latch capable of meshing with a striker; a ratchet capable of engaging with the latch; a ratchet detection switch detecting the releasing operation of the ratchet by the opening operation of a door and the engagement of the ratchet to the latch; and a door opening and closing detection switch detecting the opened state and the closed state of the door; a window regulator for opening and closing a window glass by an electric drive source, window regulator which is provided at the door; and a control device controlling the electric drive source of the window regulator, wherein the control device controls the drive of the electric drive source to open the window glass to a predetermined slight opening position on the basis that the ratchet detection switch detects the releasing operation of the ratchet, and the door opening and closing detection switch detects the opened state of the door, and wherein the control device controls the drive of the electric drive source to close the window glass on the basis that the door opening and closing detection switch detects the closed state of the door, and the ratchet detection switch detects the engagement of the ratchet to the latch.

In the first or the second invention, a third invention is characterized in that in a case where the window glass is at an opening side more than the slight opening position, the control device does not control the drive of the electric drive source to open the window glass.

In any of the first to the third inventions, a fourth invention is characterized in that the door latch device further has a locking and unlocking mechanism, wherein the locking and unlocking mechanism disables the releasing operation of the ratchet by the opening operation of an outside handle provided on the vehicle outer side of the door, and wherein the locking and unlocking mechanism enables the releasing operation of the ratchet by the opening operation of an inside handle provided on the vehicle inner side of the door.

According to the present invention, even in any type of a door latch device, it is possible to open a window glass to a slight opening position based on the opening operation of a door, and to close the window glass based on the closing operation of the door.

### BRIEF DESCRIPTION OF THE DRAWINGS

FIG. 1 is a side view of a vehicle in which a window glass opening/closing system for vehicles according to the present invention has been applied.

FIG. 2 is an enlarged sectional view taken along a line II-II of FIG. 1.

FIG. 3 is a perspective exploded view of a door latch device according to the present invention.

FIG. 4 is a front view of the door latch device.

FIG. 5 is a drawing when the door latch device is viewed from an arrow V direction of FIG. 4.

FIG. 6 is a perspective view of a meshing unit and other elements in the door latch device.

FIG. 7 is a back view of a main part of the meshing unit in an opened state.

FIG. 8 is a back view of the main part of the meshing unit in a full-latch state.

FIG. 9 is a side view of a main part of an operation unit in an unlocked state.

FIG. 10 is a side view of the main part of the operation unit in a locked state.

FIG. 11 is a block diagram explaining control of a window regulator.

FIG. 12 is a timing chart diagram explaining timing of opening/closing operation of a window glass.

### DETAILED DESCRIPTION OF THE INVENTION

In the following, an embodiment of the present invention will be explained based on the drawings.

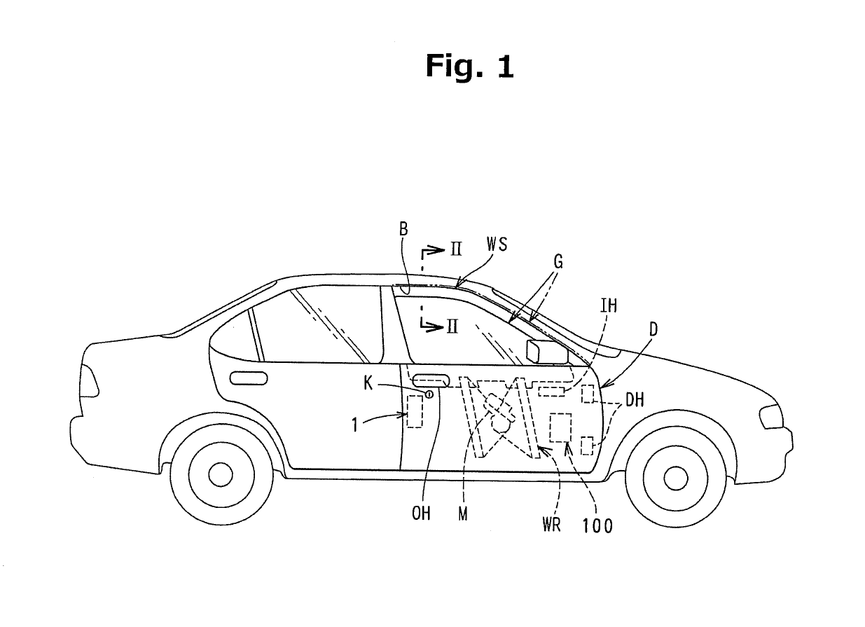

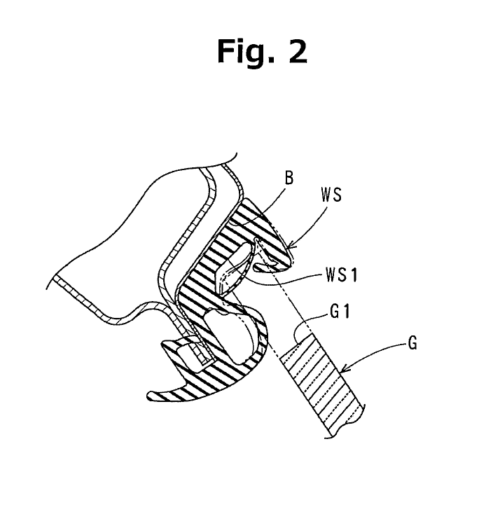

FIG. 1 is a side view of a vehicle in which a window glass opening/closing system for vehicles of the present invention has been applied, and FIG. 2 is an enlarged sectional view taken along a line II-II in FIG. 1. In addition, directions used in the following explanation indicate directions based on the vehicle.

As shown in FIG. 1, a door D at a driver's seat side of a vehicle is a sashless type door. The front part of the door D is pivotably supported to the vehicle so as to be able to be opened and closed by door hinges DH having vertical rotating shafts. A window regulator WR with which a window glass G can be vertically opened and closed by the power of a motor M for a window regulator as an electric drive source, and a door latch device 1 for keeping the door D in a locked state are disposed in the door. An outside handle OH operated when the door D is opened from the exterior of the vehicle, and a key cylinder K for locking and unlocking operation of the after-mentioned locking and unlocking mechanism are provided on the vehicle outer side of the door D. In addition, an inside handle IH operated when the door D is opened from the interior of the vehicle, and a lock knob (not shown in the drawings) for locking and unlocking operation of the locking and unlocking mechanism are provided on the vehicle inner side of the door D.

A band-shaped weather strip WS is provided at a door opening edge B of the vehicle. The weather strip WS has, for example, a cross sectional shape shown in FIG. 2. When the door D is closed, an upper edge G1 of the window glass G enters into a concave portion WS1 from below and then is fitted, and the weather strip WS seals between the window glass G and the door opening edge B. In addition, the door hinges DH and the window regulator WR having known structures are used, and their detailed explanations are therefore omitted.

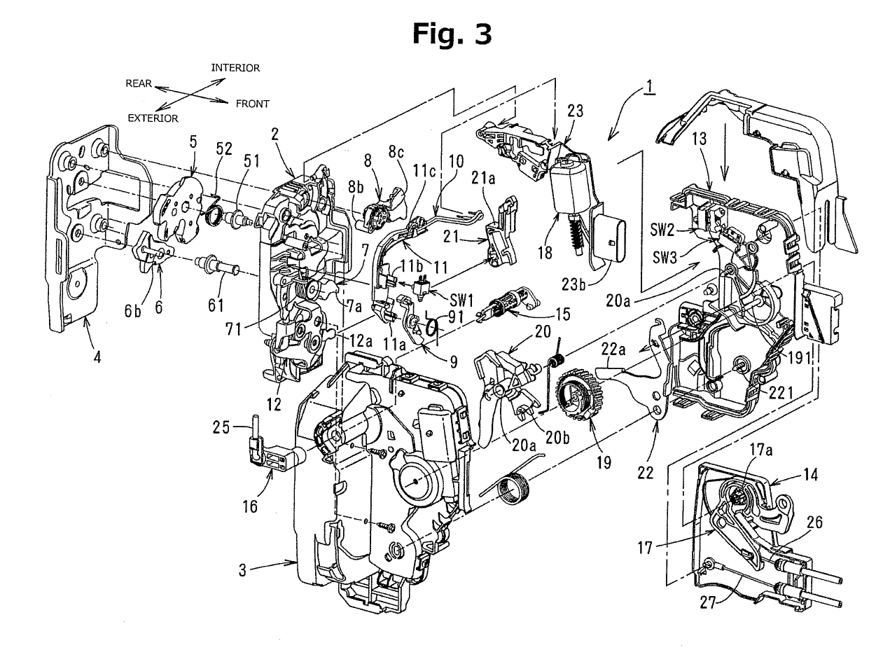

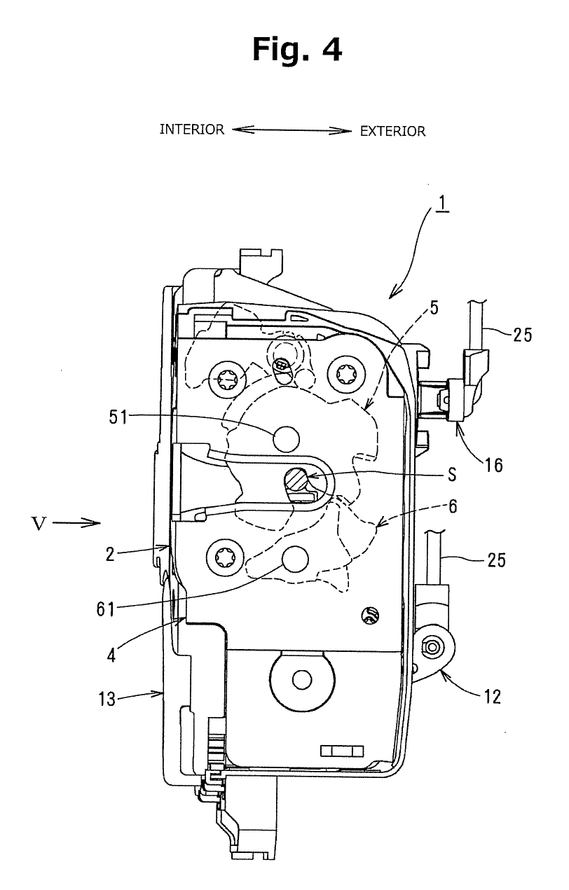

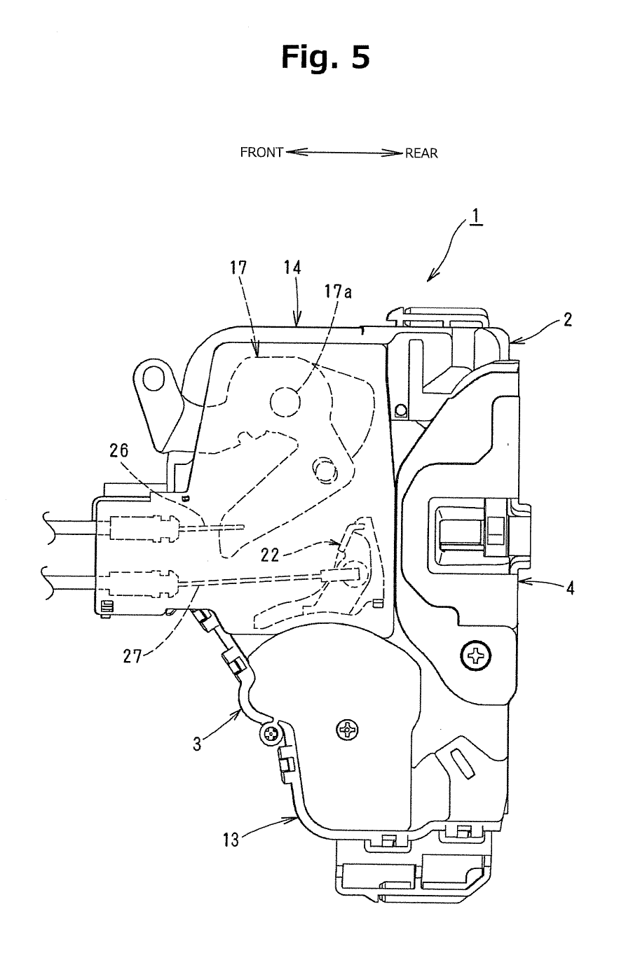

FIG. 3 is a perspective exploded view of a door latch device 1, FIG. 4 is a front view of the door latch device 1, and FIG. 5 is a drawing when the door latch device 1 is viewed from an arrow V direction of FIG. 4.

The door latch device 1 is a one-motion type door latch device configured so that the door D can be opened by one opening operation of the inside handle IH, even in a case where the locking and unlocking mechanism is in the locked state, and includes meshing unit (no reference sign) having a housing 2 for a meshing mechanism which accommodates the after-mentioned meshing mechanism for keeping the door D in the closed state by meshing with a striker S of a vehicle side, and an operation unit (no reference sign) having a housing 3 for an operation mechanism which accommodates the locking and unlocking mechanism and other elements.

The meshing unit has the housing 2 for the meshing mechanism, which is made of synthetic resin, and whose rear surface is closed by a cover plate 4 made of metal. The meshing mechanism configured including a latch 5 capable of meshing with the striker S and a ratchet 6 capable of engaging with the latch 5 is arranged in the housing 2 for the meshing mechanism (in a space made between the housing 2 for the meshing mechanism and the cover plate 4). The front surface of the housing 2 for the meshing mechanism is arranged with an open lever 7 which is capable of being integrally turned with the ratchet 6, a latch detection lever 8 which is displaced according to the turn of the latch 5, a ratchet detection lever 9 which is displaced according to the turn of the open lever 7, a ratchet detection switch SW1 which is switched on/off according to the turning position of the ratchet detection lever 9, a guide member 11 for holding an electric wire 10 electrically connected to the ratchet detection switch SW1, and an outside lever 12 connected to the outside handle OH.

The operation unit has the housing 3 for the operation mechanism which is made of synthetic resin, and is fixed to the front side of the housing 2 for the meshing mechanism, and the surface of the housing 3 which faces the interior of the vehicle is closed by a main cover 13 made of synthetic resin and a sub-cover 14 fixed to the surface of the main cover 13 which faces the interior of the vehicle.

The housing 3 for the operation mechanism is arranged with a first and a second key levers 15, 16 which are linked with the operation of the key cylinder K, a knob lever 17 connected to the lock knob, a motor 18 which can be driven by the locking and unlocking operation of an operation switch (not shown in the drawings) provided at a portable apparatus or in the vehicle, a worm wheel 19 turned by the drive of the motor 18, a locking lever 20 and a lift lever 21 which are movable to an unlocking position at which the opening operation of the outside handle OH is enabled and to a locking position at which the opening operation of the outside handle OH is disabled, an inside lever 22 connected to the inside handle IH, a door opening and closing detection switch SW2 which is switched on/off according to the turning position of the latch 5 through the latch detection lever 8, a locking and unlocking detection switch SW3 which is switched on/off according to the turning position of the locking lever 20, and a switch plate 23 supporting the door opening and closing detection switch SW2 and the locking and unlocking detection switch SW3.

A detection signal of each of the ratchet detection switch SW1, the door opening and closing detection switch SW2 and the locking and unlocking detection switch SW3 is sent to a control device 100 disposed at a proper place of the door D or a vehicle body. The control device 100 performs the drive control of a motor M for the window regulator, based on the signal sent from each of the switches SW1 and SW2.

In the present embodiment, the locking and unlocking mechanism is configured by the locking lever 20 and the lift lever 21. The configuration of the locking and unlocking mechanism can be variously modified according to a vehicle type adopting the door latch device 1, not limited to a one-motion type door latch device, and may be a so-called normal type door latch device in which the door D cannot be opened by the opening operation of the outside handle OH and the inside handle IH in the locked state.

The door latch device 1 explained in the present embodiment is a one-motion type. In this type, “unlocked state” indicates a state in which each of the locking lever 20 and the lift lever 21 is at the unlocking position, and the door D can be opened by opening operation of the outside handle OH or the inside handle IH, and “locked state” indicates a state in which each of the locking lever 20 and the lift lever 21 is at the locking position, and the door D cannot be opened by the opening operation of the outside handle OH but can be opened by the opening operation of the inside handle IH.

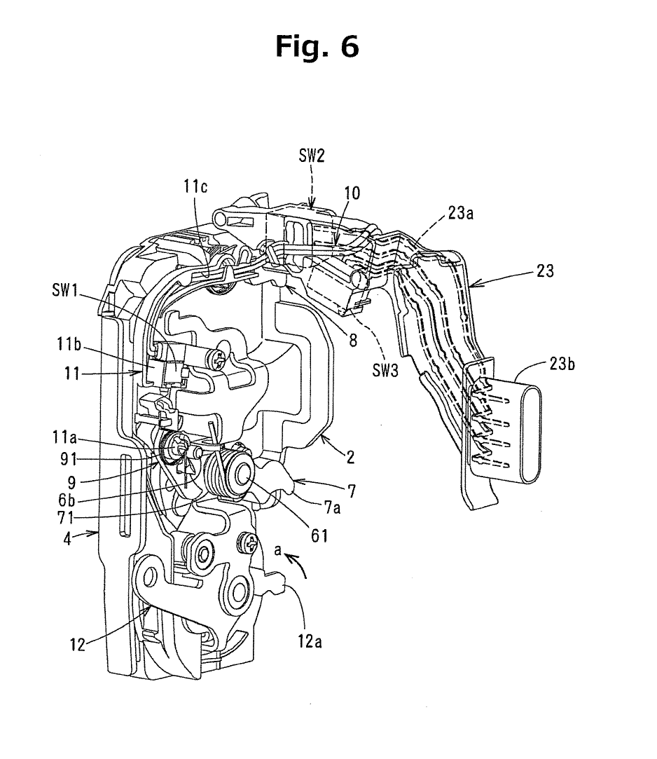

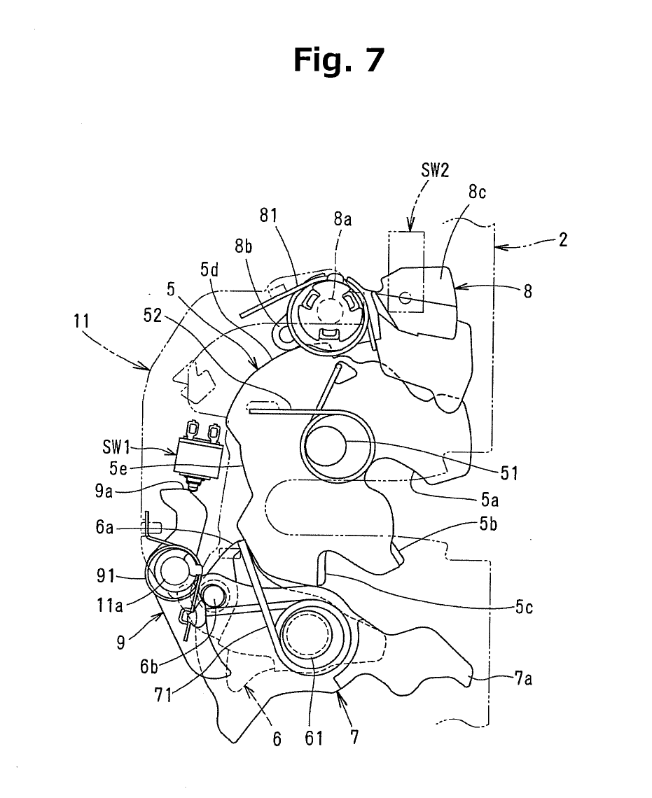

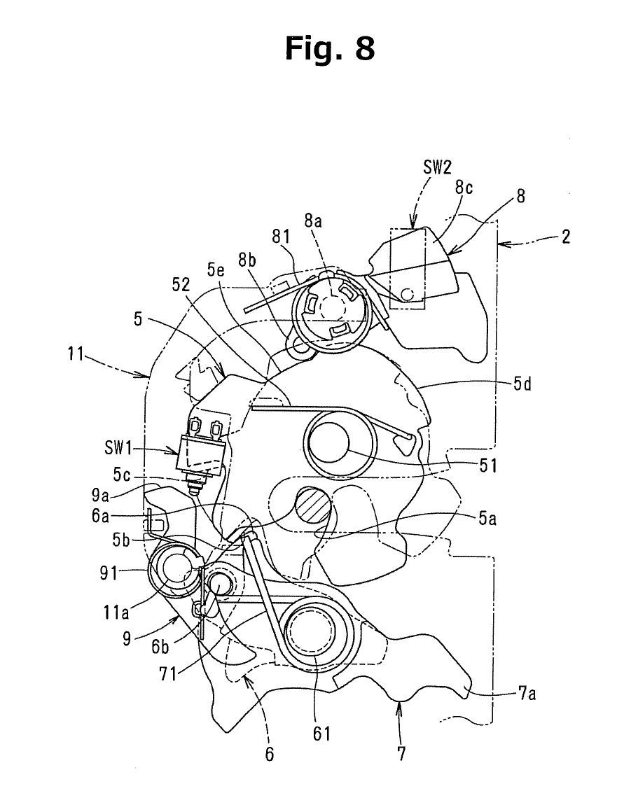

FIG. 6 is a perspective view of the meshing unit when viewed from the back side. FIG. 7 is a back view of a main part of the meshing unit when the latch 5 is at an opening position (at a position corresponding to the opened state of the door D), and FIG. 8 is a back view of the main part of the meshing unit when the latch 5 is at a full-latch position (at a position corresponding to the full-closed state of the door D).

The latch 5 of the meshing mechanism in the meshing unit is pivotably supported on a latch shaft 51 facing in the front and rear direction of the vehicle in the housing 2 for the meshing mechanism, and has a meshing groove 5a with which the striker S can mesh, a full-latch engaging part 5b and a half-latch engaging part 5c with which a claw part 6a of the ratchet 6 can engage from below, a convex part 5d radially bulging from the outer peripheral edge of the latch 5, and a concave part 5e radially recessed more than the convex part 5d. By the closing operation of the door D, the latch 5 is turned clockwise at a predetermined angle against the biasing force of a spring 52 acting on the latch 5 from the opening position (a position shown in FIG. 7) to the full-latch position (a position shown by a solid line in FIG. 8) at which the striker S completely meshes with the meshing groove 5a, after passing through a half-latch position (a position shown by a long dashed double short dashed line in FIG. 8) at which the striker S slightly meshes with the meshing groove 5a, and vice versa by the opening operation of the door D.

The convex part 5d of the latch 5 has an arc shape having a predetermined length circumferentially about the latch shaft 51 as a center, and radially bulging more than the concave part 5e.

The ratchet 6 is pivotably supported on a ratchet shaft 61 facing in the front and rear direction in the housing 2 for the meshing mechanism, and is biased in an engaging direction (in a clockwise direction in FIG. 7 and FIG. 8) by a spring 71 acting on the open lever 7. When the latch 5 is turned in a closing direction (in the clockwise direction in FIG. 7) from the opening position, the claw part 6a engages with the half-latch part 5c, and the latch 5 is held at the half-latch position (in a state in which the door D is ajar). When the latch 5 is further turned in the closing direction from the half-latch position, the claw part 6a engages with the full-latch engaging part 5b, and the latch 5 is held at the full-latch position (in a full-closed state). In addition, in a case where the releasing operation (a turning in a counterclockwise direction in FIG. 8) of the ratchet 6 is performed based on the opening operation of the outside handle OH or the inside handle IH, the claw part 6a comes off from the full-latch engaging part 5b or the half-latch engaging part 5c, and consequently, the turning of the latch 5 to the opening position becomes possible, and thereby the opening of the door D becomes possible.

A projecting portion 6b having a columnar shape which projects in the front direction is provided at an end part of the ratchet 6. The projecting portion 6b extends through a long hole (not shown in the drawings) provided on the housing 2 for the meshing mechanism, and engages with the open lever 7.

The open lever 7 is supported pivotably rotatably on the ratchet shaft 61 on the front surface of the housing 2 for the meshing mechanism, and engages with the projecting portion 6b of the ratchet 6, and is integrally turned with the ratchet 6. An arm-shaped part 7a to be released is provided at the end part of the open lever 7 which extends to the interior direction of the vehicle (a right side in FIG. 7 and FIG. 8).

The ratchet 6 and the open lever 7 are stopped at an engaging position to the latch 5 shown in FIG. 8 when the claw part 6a of the ratchet 6 engages with the full-latch engaging part 5b or the half-latch engaging part 5c, and when the claw part 6a does not engage with both of the full-latch engaging part 5b and the half-latch engaging part 5c, the ratchet 6 and the open lever 7 are turned counterclockwise at a predetermined angle from the engaging position, and stopped at a releasing position shown in FIG. 7. In this position, the claw part 6a contacts the outer peripheral edge of the latch 5. In addition, in a case where the releasing operation of the ratchet 6 and the open lever 7 is performed based on the opening operation of the outside handle OH or the inside handle IH, they are slightly turned counterclockwise from the releasing position.

The latch detection lever 8 is pivotably supported on a shaft part 8a facing in the front and rear direction at the upper part of the front surface of the housing 2 for the meshing mechanism, and is biased counterclockwise in FIG. 7 and FIG. 8 by a spring 81. In addition, the latch detection lever 8 has, at an end part thereof, a detection portion 8b which extends through a long hole (not shown in the drawings) provided at the upper part of the housing 2 for the meshing mechanism and can be brought into contact with the concave part 5e and the convex part 5d.

The detection portion 8b slides relatively circumferentially on the concave part 5e and the convex part 5d with the turning of the latch 5. When the latch 5 is at the opening position and at the half-latch position, the detection portion 8b is at a position on the convex part 5d, as shown in FIG. 7, and when the latch 5 is at the full-latch position or at a position immediately before the full-latch position (at a position between the half-latch position and the full-latch position), the detection portion 8b is displaced to a position on the concave part 5e, as shown in FIG. 8.

The latch detection lever 8 is stopped at an unlatch position shown in FIG. 7 at which the detection portion 8b is on the convex part 5d, and when the detection portion 8b is displaced onto the concave part 5e from on the convex part 5d, the latch detection lever 8 is turned counterclockwise at a predetermined angle from the unlatch position and is stopped at a latch position shown in FIG. 8.

As shown in FIG. 6, the guide member 11 is fixed to the upper part of the front surface of the housing 2 for the meshing mechanism, and has a shaft part 11a to pivotably support the ratchet detection lever 9, a holding portion 11b to hold the ratchet detection switch SW1, holding portion 11b which is positioned at the upper side of the shaft part 11a, and a guide groove 11c to guide the electric wire 10 toward the switch plate 23, which is electrically connected to the ratchet detection switch SW1.

The ratchet detection lever 9 is supported on the shaft part 11a of the guide member 11, and is biased counterclockwise in FIG. 7 and FIG. 8 by a spring 91, and the right side at the lower part of the ratchet detection lever 9 in FIG. 7 and FIG. 8 is brought into contact with the left side surface of the projecting portion 6b of the ratchet 6. With this, when the ratchet 6 and the open lever 7 are stopped at the engaging position, the ratchet detection lever 9 is stopped at an engaging position (at a position shown in FIG. 8), and when the ratchet 6 and the open lever 7 are stopped at the releasing position, the ratchet detection lever 9 is turned clockwise from the engaging position to a releasing position (a position shown in FIG. 7). In a case where the releasing operation of the ratchet 6 and the open lever 7 is performed, the ratchet detection lever 9 is slightly turned clockwise from the releasing position (hereinafter, this turning is called as “releasing operation”).

The ratchet detection switch SW1 is held by the holding portion 11b of the guide member 11. As shown in FIG. 8, in a case where the ratchet detection lever 9 is at the engaging position, an upper end portion 9a of the ratchet detection lever 9 does not contact the ratchet detection switch SW1, and the ratchet detection switch SW1 is held in an off state. As shown in FIG. 7, in a case where the ratchet detection lever 9 is at the releasing position, and in a case where the releasing operation is performed, the upper end portion 9a of the ratchet detection lever 9 contacts the ratchet detection switch SW1, and the ratchet detection switch SW1 is switched to an on state.

The opening operation (a turning in a direction shown by an arrow “a” in FIG. 6) of the outside lever 12 is performed by the opening operation of the outside handle OH. By this opening operation, in a case where the locking and unlocking mechanism is in the unlocked state, it is possible to open the door D by releasing the engaging relation between the ratchet 6 and the latch 5 by turning the open lever 7, and in a case where the locking and unlocking mechanism is in the locked state, the lift lever 21 connected to the outside lever 12 fails to contact the open lever 7. Consequently, it is not possible to open the door D by the opening operation of the outside handle OH.

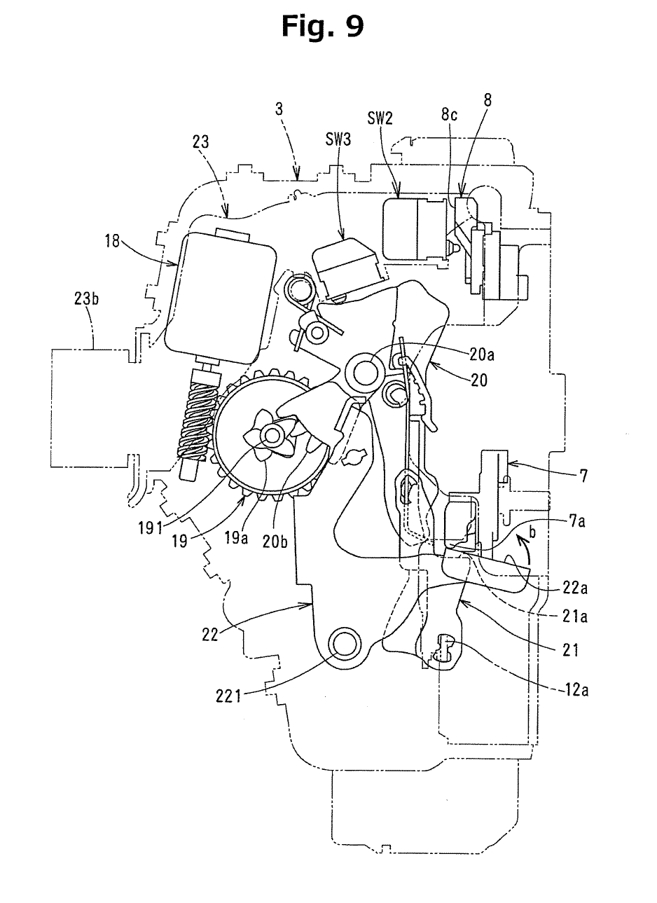

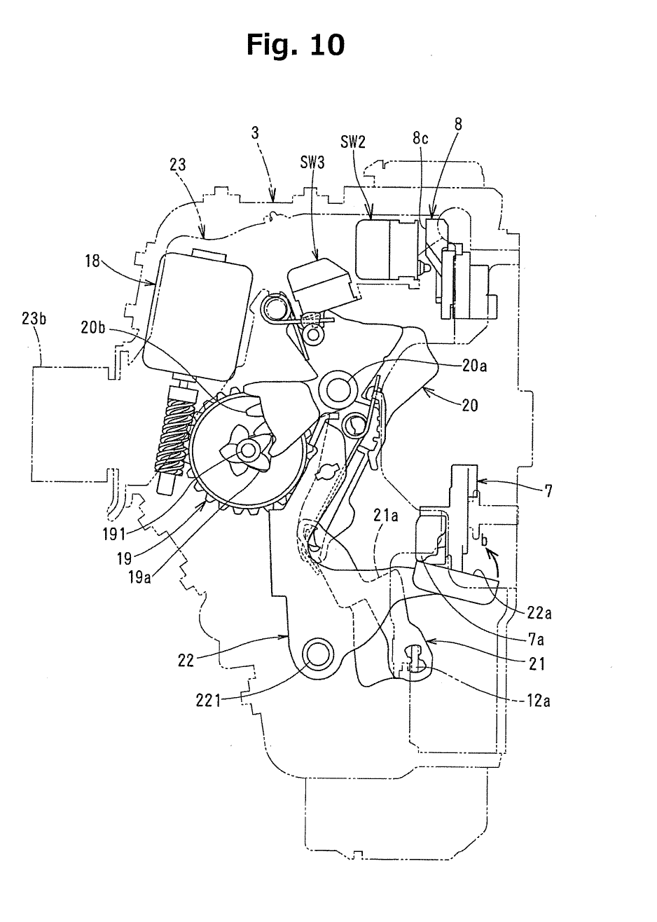

FIG. 9 is a side view of a main part of the operation unit when the locking and unlocking mechanism of the operation unit is in the unlocked state. FIG. 10 is a side view of the main part of the operation unit when the locking and unlocking mechanism of the operation unit is in the locked state.

As shown in FIG. 3, the first key lever 15 of the operation unit is pivotably supported at the upper part of the housing 3 for the operation mechanism. In addition, by connecting the second key lever 16 to the key cylinder K, second key lever 16 which is provided at the outside of the housing 3 for the operation mechanism and integrally turned with the first key lever 15, through an operating force transmission member 25, such as a rod, the first key lever 15 is turned at a predetermined angle interlocking with the locking and unlocking operation of the key cylinder K, and this turning is transmitted to the locking lever 20.

The knob lever 17 is pivotably supported on a shaft part 17a facing in the interior and exterior direction of the vehicle in the inner side surface of the sub-cover 14. In addition, by connecting the knob lever 17 to the lock knob through an operation force transmission member 26, such as a Bowden cable, the knob lever 17 is turned to an unlocking position show in FIG. 5, or is turned clockwise at a predetermined angle from the unlocking position to a locking position, interlocking with the locking and unlocking operation of the lock knob.

The motor 18 starts to be driven by the locking and unlocking operation by, for example, a portable apparatus, and the worm wheel 19 pivotably supported on a shaft 191 in the housing 3 for the operation mechanism is turned.

The locking lever 20 is supported in the housing 3 for the operation mechanism so as to be turned at a predetermined angle around a shaft part 20a as a center and is connected to each of the first key lever 15 and the knob lever 17, and a sector gear part 20b provided at a peripheral edge of the locking lever 20 meshes with a gear part 19a of the worm wheel 19. With this, the locking lever 20 is turned clockwise at a predetermined angle from an unlocking position shown in FIG. 9 to a locking position shown in FIG. 10, and vice versa, by the turning of the first key lever 15 or the knob lever 17 by manual operation (the locking and unlocking operation of the key cylinder K or the lock knob), or by the turning of the worm wheel 19 by the drive of the motor 18 based on the locking and unlocking operation of, for example, a portable apparatus. In addition, the locking lever 20 is configured so that the sector gear part 20b fails to mesh with the gear part 19a in a case where the locking lever 20 is turned by manual operation, and thereby the turning of the locking lever 20 is not transmitted to the motor 18.

The lower end part of the lift lever 21 is connected to an end portion 12a of the outside lever 12 so as to be swingable, and the upper end part of the lift lever 21 is connected to the locking lever 20 so as to be swingable and vertically movable. With this, the lift lever 21 can be turned to an unlocking position show in FIG. 9, and can be turned counterclockwise at a predetermined angle from the unlocking position shown in FIG. 9 to a locking position shown in FIG. 10 about the end portion 12a of the outside lever 12 as a center, interlocking with the locking and unlocking operation of the locking lever 20, and moves upward with the opening operation of the outside lever 12.

In a case where the lift lever 21 moves upward in the unlocking position, a releasing part 21a provided at a substantially middle part in the vertical direction of the lift lever 21 contacts the part 7a to be released of the open lever 7 from below, and the releasing operation of the open lever 7 and the ratchet 6 is performed. Consequently, the engaging relation between the ratchet 6 and the latch 5 is released, and the door D can be opened. In addition, in a case where the lift lever 21 moves upward in the locking position, the releasing part 21a fails to contact the part 7a to be released of the open lever 7, and the ratchet 6, as a result, cannot be turned to the releasing direction. Consequently, it is not possible to open the door D.

The inside lever 22 is pivotably supported on a shaft 221 at the lower part of the housing 3 for the operation mechanism, and is connected to the inside handle IH through an operation force transmission member 27 formed of, for example, Bowden cable. With this, the inside lever 22 is turned at a predetermined angle in an opening direction (in a direction shown by an arrow “b” in FIG. 9 and FIG. 10), interlocking with the opening operation of the inside handle IH. In a case where the inside lever 22 is turned in the opening direction, a releasing part 22a provided at the end part of the inside lever 22 contacts the part 7a to be released of the open lever 7 from below, even in a case where the locking and unlocking mechanism is in the unlocked state and in the locked state, and the releasing operation of the open lever 7 and the ratchet 6 is performed, and consequently, the door D can be opened.

The door opening and closing detection switch SW2 is held at the switch plate 23. As shown in FIG. 7, in a case where the latch detection lever 8 is at the unlatch position, a cam part 8c contacts the door opening and closing detection switch SW2, and the door opening and closing detection switch SW2 is switched to an on state, and then, for example, a room lamp in the vehicle is turned on. In addition, as shown in FIG. 8, in a case where the latch detection lever 8 is at the latch position, the door opening and closing detection switch SW2 does not contact the cam part 8c and is switched to an off state, and then the room lamp is turned off.

In addition, since the door opening and closing detection switch SW2 serves as a switch for turning on and off the room lamp, a timing at which the door opening and closing detection switch SW2 is switched from the off state to the on state and vise verse is set to a timing at which the latch 5 is at the position between the half-latch position and the full-latch position.

As shown in FIG. 6, the switch plate 23 has a plurality of conducting plates 23a for energization and is formed by insert-molding with a synthetic resin material so as to cover the conducting plates 23a, and is fixed to the housing 3 for the operation mechanism. An external connector (not shown in the drawings) is electrically connected to a cylindrical coupler 23b integrally formed with the switch plate 23, and thereby power of a battery mounted on the vehicle is supplied to the motor 18 and a signal outputted from each of the ratchet detection switch SW1, the door opening and closing detection switch SW2 and the locking and unlocking detection switch SW3 is sent to the control device 100 mounted on the vehicle.

The motor 18, the door opening and closing detection switch SW2 and the locking and unlocking detection switch SW3 are directly connected to the conducting plates 23a. The ratchet detection switch SW1 is connected to the conducting plate 23a through the electric wire 10 wired on the guide member 11.

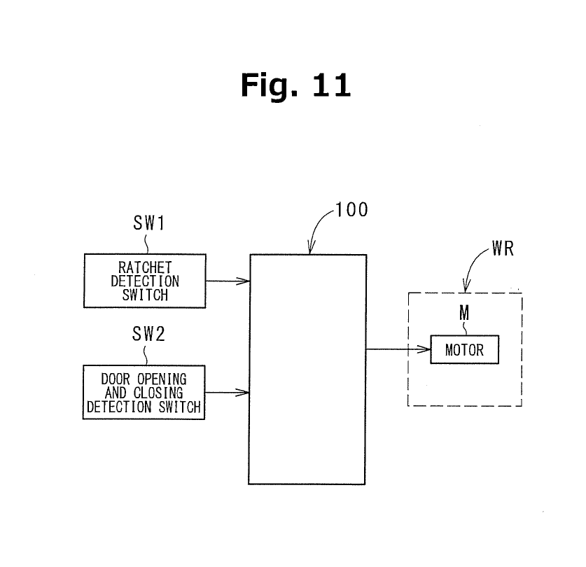

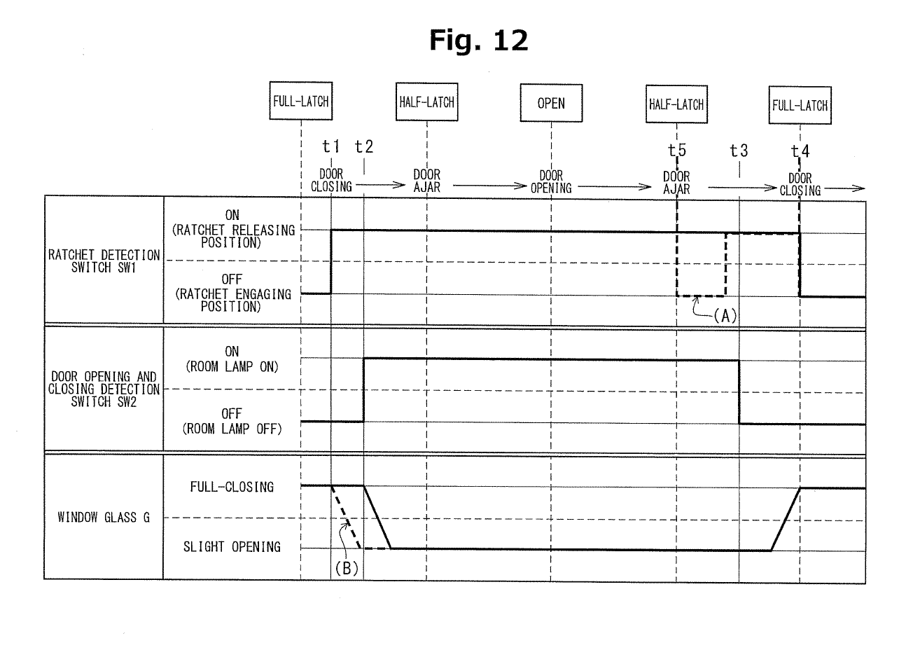

FIG. 11 is a block diagram explaining a control circuit. FIG. 12 is a timing chart diagram explaining a timing at which the opening and closing operation of the window glass G is performed.

Each of the battery (not shown in the drawings) mounted on the vehicle, the ratchet detection switch SW1, the door opening and closing detection switch SW2 and the motor M for the window regulator is electrically connected to the control device 100. The control device 100 has, in addition to a function to control the motor M for the window regulator according to the state of each of the ratchet detection switch SW1 and the door opening and closing detection switch SW2, a function to calculate the moving direction, the amount of the movement and the current position of the window glass G based on a pulse signal outputted from a pulse encoder (not shown in the drawings) which detects a turning angle of a speed reduction gear rotated by the motor M for the window regulator.

As shown in FIG. 12, by the opening operation of the door D, after a timing t1 at which the ratchet detection switch SW1 is switched from the off state (in a state in which the ratchet 6 is at the engaging position) to the on state (in a state in which the releasing operation of the ratchet 6 is performed), at a timing t2 at which the door opening and closing detection switch SW2 is switched from the off state (in a state in which the latch 5 is at the full-latch position) to the on state (in a state in which the latch 5 is at the position between the full-latch position and the half-latch position), if the window glass G is at a full-closing position, the control device 100 controls the drive of the motor M for the window regulator to open the window glass G to a predetermined slight opening position (a position shown in a solid line in FIG. 1 and FIG. 2 at which the upper edge G1 of the window glass G has slightly come out of the concave portion WS1 of the weather strip WS). In addition, if the window glass G is at a position at which the window glass G has been opened more than the slight opening position, the control device 100 does not control the drive of the motor M for the window regulator.

Moreover, by the closing operation of the door D, after a timing t3 at which the door opening and closing detection switch SW2 is switched from the on state (in the state in which the latch 5 is at the opening position) to the off state (in the state in which the latch 5 is at the position between the half-latch position and the full-latch position), at a timing t4 at which the ratchet detection switch SW1 is switched from the on state (in the state in which the ratchet 6 is at the releasing position) to the off state (in the state in which the ratchet 6 is at the engaging position), if the window glass G is at the slight opening position, the control device 100 controls the drive of the motor M for the window regulator to close the window glass G to the full-closing position.

Next, a function of the window glass opening/closing system for vehicles will be explained.

<In a Case where the Opening Operation of the Door D is Performed>

In a state in which the door D is in the full-closed state, the latch 5 is at the full-latch position, the ratchet 6 is at the engaging position and the locking and unlocking mechanism is in the unlocked state, when the opening operation of the outside handle OH is performed, by the opening operation of the outside lever 12, the lift lever 21 moves upward in the unlocking position, and the releasing part 21a contacts the part 7a to be released of the open lever 7, and the releasing operation of the open lever 7 and the ratchet 6 is, as a result, performed. In addition, when the opening operation of the inside handle IH is performed, the opening operation of the inside lever 22 is performed, and the releasing part 22a directly contacts the part 7a to be released, and the releasing operation of the open lever 7 and the ratchet 6 is, as a result, performed.

In addition, in a state in which the door D is in the full-closed state, the latch 5 is at the full-latch position, the ratchet 6 is at the engaging position and the locking and unlocking mechanism is in the locked state, when the opening operation of the outside handle OH is performed, by the opening operation of the outside lever 12, the lift lever 21 moves upward. It is, however, not possible to open the door D since the releasing operation of the open lever 7 is not performed. However, when the opening operation of the inside handle IH is performed, even if the locking and unlocking mechanism is in the locked state, by the opening operation of the inside lever 22, the releasing part 22a directly contacts the part 7a to be released, and the releasing operation of the open lever 7 and the ratchet 6 is performed.

In a case where the releasing operation of the open lever 7 and the ratchet 6 is performed regardless the state of the locking and unlocking mechanism, the ratchet detection switch SW1 is switched from the off state to the on state at the timing t1 shown in FIG. 12. When the latch 5 is slightly turned in the opening direction from the full-latch position by seal reaction force acting on the door D, the door opening and closing detection switch SW2 is switched from the off state to the on state at the timing t2 shown in FIG. 12.

When the control device 100, immediately after receiving a signal that the ratchet detection switch SW1 is switched from the off state to the on state, receives a signal that the door opening and closing detection switch SW2 is switched from the off state to the on state, at this time, in a case where the window glass G is at the full-closing position or a closing side more than the slight opening position, the control device 100 immediately executes the drive control of the motor M for the window regulator to open the window glass G to the slight opening position.

With this execution, by the opening operation of the door D, the window glass G automatically moves and then is stopped at the slight opening position at which the upper edge G1 is at a position out of the concave portion WS1 of the weather strip WS. In addition, in a case where the window glass G is at an opening side more than the slight opening position, it is not necessary to perform the opening operation of the window glass G since the window glass G is in a state in which the upper edge G1 of the window glass G is at the position out of the concave portion WS1 of the weather strip WS. The drive control of the motor M for the window regulator is therefore not executed.

<In a Case where the Door D Becomes the Full-Closed State by the Closing Operation>

In a state in which the door D is opened, the latch 5 is at the opening position and the ratchet 6 is at the releasing position, and as shown in FIG. 12, the door opening and closing detection switch SW2 and the ratchet detection switch SW1 are kept in the on states.

At a time when the door D is closed, the latch 5 is turned in the closing direction from the opening position to the position between the half-latch position and the full-latch position passing through the half-latch position, and the striker S meshes with the meshing groove 5a of the latch 5. At this time, the door opening and closing detection switch SW2 is switched from the on state to the off state at the timing t3 shown in FIG. 12. After that, the ratchet 6 engages with the full-latch engaging part 5b of the latch 5 and is displaced to the engaging position, and the ratchet detection switch SW1 is switched from the on state to the off state at the timing t4 show in FIG. 12.

When the latch 5 passes through the half-latch position, there is a case where the ratchet 6 is once displaced to the engaging position. This displacement, however, occurs for an instant, the switching signal of the ratchet detection switch SW1 at that time is therefore ignored.

When the control device 100 receives a signal that the ratchet detection switch SW1 is switched from the on state to the off state after receiving a signal that the door opening and closing detection switch SW2 is switched from the on state to the off state, in a case where the window glass G is at the slight opening position at that time, the control device 100 executes the driving control of the motor M for the window regulator to close the window glass G to the full-closing position. In addition, in a case where the window glass G is at the opening side more than the slight opening position, it can be considered that a user opens the window glass G intentionally, and therefore the control for closing the window glass G is not basically executed. However, the control for automatically closing the window glass G may be executed to prevent the window glass G from being left open as needed.

As mentioned above, at the time when the door D becomes in the full-closed state, the window glass G is automatically closed from the slight opening position to the full-closing position. Consequently, it is possible to prevent that the closing force of the door D becomes large due to the increase of the pressure inside the vehicle at the moment when the door D is closed, and to improve sealing performance by surely fitting the upper edge G1 of the window glass G to the concave portion WS1 of the weather strip WS.

<In a Case where the Door D is Ajar (a Door Ajar State) by the Closing Operation>

In this case, by the closing operation of the door D, the latch 5 is turned in the closing direction from the opening position. The door D, however, becomes the door ajar state, and the latch 5 is stopped at the half-latch position. In this state, since the ratchet 6 engages with the half-latch engaging part 5c and is stopped at the engaging position, the ratchet detection switch SW1 is switched from the on state to the off state at a timing t5 shown in FIG. 12. However, the latch 5 is stopped at the half-latch position, and the door opening and closing detection switch SW2 is kept in the on state. Consequently, in this door ajar state, the closing operation of the window glass G is not performed even if the ratchet detection switch SW1 is switched from the on state to the off state.

In addition, in a case where the door D becomes the full-closed state from the door ajar state by being pushed in a door closing direction, by the turning of the latch 5 to the full-latch position, the ratchet 6 is once displaced from the engaging position to the releasing position, and then is returned to the engaging position by engaging with the full-latch engaging part 5b. Consequently, in this case, as shown in a time chart shown in “A” with a dotted line in FIG. 12, after being switched from the off state to the on state once, the ratchet detection switch SW1 is switched to the off state again. At this time, since the door opening and closing detection switch SW2 had been switched from the on state to the off state, the window glass G is automatically closed at the time when the ratchet detection switch SW1 is switched to the off state.

As mentioned above, the window glass opening/closing system for vehicles of the present embodiment is configured so as to control the drive of the motor M for the window regulator to close the window glass G on the basis that the door opening and closing detection switch SW2 detects the full-closed state of the door D (a switch from the on state to the off state), following which the ratchet detection switch SW1 detects that the ratchet 6 is at the engaging position (a switch from the on state to the off state). With this configuration, it is possible to surely enter the upper edge G1 of the window glass G into the concave portion WS1 of the weather strip WS, thereby improving the sealing performance between the weather strip WS and the window glass G.

Although the invention has been described above with reference to the embodiment of the present invention, the invention is not limited to the embodiment described above. The following modifications and variations of the embodiment can be possible, within the scope of the present invention.

(a) The present invention is applied to a door type having a sash for guiding the lifting and the lowering of the window glass G.
(b) The latch detection lever 8 is omitted, and the door opening and closing detection switch SW2 directly detects the position of the latch 5.
(c) The ratchet detection lever 9 is omitted, and the ratchet detection switch SW1 detects the position of the ratchet 6 through the open lever 7, or the ratchet detection lever 9 and the open lever 7 are omitted, and the ratchet detection switch SW1 directly detects the position of the ratchet 6.
(d) A normal type of the locking and unlocking mechanism of the door latch device 1 is used instead of the one motion type thereof. Here, the normal type is a type in which when the locking and unlocking mechanism is in the unlocked state, it is possible to open the door D by the opening operation of the outside handle OH and the opening operation of the inside handle IH, and when the locking and unlocking mechanism is in the locked state, it is not possible to open the door D by the opening operation of the outside handle OH and the opening operation of the inside handle IH.
(e) The timing at which the window glass G is opened to the slight opening position is set to a timing at which the ratchet detection switch SW1 is switched from the off state (the ratchet 6 is at the engaging position) to the on state (the ratchet 6 is at the releasing position) by the releasing operation of the ratchet 6 by the opening operation of the outside handle OH or the inside handle IH, that is, the timing t1 shown in FIG. 12, and at this timing, the slight opening position of the window glass G is performed, as shown in an operation chart shown in “B” with a dotted line in FIG. 12.

In the window glass opening/closing system for vehicles configured described above, if the door D is in a state to be opened, it is possible to perform the slight opening operation of the window glass G at the approximately the same time as the opening operation of the outside handle OH or the inside handle IH.

(f) The slight opening position of the window glass G is changed as appropriate.
(g) The (a) to the (f) described above are combined as appropriate.

This application is based on a prior Japanese Patent Application No. 2016-205942 filed on Oct. 20, 2016. This entire contents of this application are hereby incorporated by reference.

The scope of the invention is defined with reference to the following claims.

1. A window glass opening/closing system for vehicles, comprising:
a door latch device including:
a latch capable of meshing with a striker;
a ratchet capable of engaging with the latch;
a ratchet detection switch detecting releasing operation of the ratchet by opening operation of a door and engagement of the ratchet to the latch; and
a door opening and closing detection switch detecting an opened state and a closed state of the door;
a window regulator for opening and closing a window glass by an electric drive source, the window regulator which is provided at the door; and
a control device controlling the electric drive source of the window regulator,
wherein the control device controls drive of the electric drive source to open the window glass to a predetermined slight opening position on the basis that the ratchet detection switch detects the releasing operation of the ratchet, and
wherein the control device controls the drive of the electric drive source to close the window glass on the basis that the door opening and closing detection switch detects the closed state of the door, and the ratchet detection switch detects the engagement of the ratchet to the latch.

2. A window glass opening/closing system for vehicles, comprising:
a door latch device including:
a latch capable of meshing with a striker;
a ratchet capable of engaging with the latch;
a ratchet detection switch detecting releasing operation of the ratchet by opening operation of a door and engagement of the ratchet to the latch; and
a door opening and closing detection switch detecting an opened state and a closed state of the door;
a window regulator for opening and closing a window glass by an electric drive source, the window regulator which is provided at the door; and
a control device controlling the electric drive source of the window regulator,
wherein the control device controls drive of the electric drive source to open the window glass to a predetermined slight opening position on the basis that the ratchet detection switch detects the releasing operation of the ratchet, and the door opening and closing detection switch detects the opened state of the door, and
wherein the control device controls the drive of the electric drive source to close the window glass on the basis that the door opening and closing detection switch detects the closed state of the door, and the ratchet detection switch detects the engagement of the ratchet to the latch.

3. The window glass opening/closing system for vehicles according to claim 1, wherein in a case where the window glass is at an opening side more than the slight opening position, the control device does not control the drive of the electric drive source to open the window glass.

4. The window glass opening/closing system for vehicles according to claim 2, wherein in a case where the window glass is at an opening side more than the slight opening position, the control device does not control the drive of the electric drive source to open the window glass.

5. The window glass opening/closing system for vehicles according to claim 1, wherein the door latch device further comprises a locking and unlocking mechanism,
wherein the locking and unlocking mechanism disables the releasing operation of the ratchet by opening operation of an outside handle provided on a vehicle outer side of the door, and
wherein the locking and unlocking mechanism enables the releasing operation of the ratchet by opening operation of an inside handle provided on a vehicle inner side of the door.

6. The window glass opening/closing system for vehicles according to claim 2, wherein the door latch device further comprises a locking and unlocking mechanism,
wherein the locking and unlocking mechanism disables the releasing operation of the ratchet by opening operation of an outside handle provided on a vehicle outer side of the door, and
wherein the locking and unlocking mechanism enables the releasing operation of the ratchet by opening operation of an inside handle provided on a vehicle inner side of the door.
